(19) United States
(12) Patent Application Publication
(10) Pub. No.: US 2016/0160963 A1
(43) Pub. Date: Jun. 9, 2016

(54) MULTI-SPEED AUTOMATIC TRANSMISSION

(71) Applicant: Hyundai Motor Company, Seoul (KR)

(72) Inventors: Seong Wook JI, Ansan-si (KR); Jae Chang KOOK, Hwaseong-si (KR); Won Min CHO, Hwaseong-si (KR); Myeong Hoon NOH, Seongnam-si (KR); Kang Soo SEO, Yongin-si (KR); Seong Wook HWANG, Gunpo-si (KR)

(73) Assignee: Hyundai Motor Company, Seoul (KR)

(21) Appl. No.: 14/835,378

(22) Filed: Aug. 25, 2015

(30) Foreign Application Priority Data
Dec. 8, 2014 (KR) 10-2014-0175093

(51) Int. Cl. F16H 3/66

(52) U.S. Cl. CPC F16H 3/66; F16H 2200/0069; F16H 2200/0073; F16H 2200/2012; F16H 2200/2046; F16H 2003/447

(57) ABSTRACT

A multi-speed automatic transmission may include a first planetary gear set connected to a transmission input shaft, a second planetary gear set connected to the first planetary gear set, a third planetary gear set connected to the second planetary gear set, a fourth planetary gear set connected between the third planetary gear set and a transmission output shaft, and six friction elements configured to selectively couple and decouple a connection among the first to fourth planetary gear sets to generate various gear ratios between the transmission input shaft and the transmission output shaft to implement a plurality of gear stages, in which at least three of the six friction elements are selectively coupled and operated at each gear stage.

### CROSS-REFERENCE TO RELATED APPLICATION

The present application claims priority to Korean Patent Application No. 10-2014-0175093, filed Dec. 8, 2014, the entire contents of which is incorporated herein for all purposes by this reference.

### BACKGROUND OF THE INVENTION

1. Field of the Invention

The present invention relates to an automatic transmission, and more particularly, to a multi-speed automatic transmission capable of implementing 10 forward speeds or more and 1 reverse stage.

2. Description of Related Art

Generally, a multi-speed shift mechanism of an automatic transmission is implemented by combining a plurality of planetary gear sets and a power train in which the plurality of planetary gear sets are combined and receives a torque from a torque converter to shift the received torque and transfer the shifted torque to an output shaft.

In the automatic transmission, as the number of gear stages which may be implemented is increased, a gear ratio may be more appropriately designed and a vehicle having excellent power performance and fuel efficiency may be implemented. Therefore, a study on an automatic transmission which may implement the larger number of gear stages has drawn steady attention.

Further, even though the same number of gear stages is implemented, durability, power transfer efficiency, a size, and the like of the power train are changed depending on a combination method of planetary gear sets. Therefore, attempts to develop a power train configuration which is more rigid, has no power loss, and is more compact have been continuously conducted.

In particular, a development for an automatic transmission which may implement high fuel efficiency for coping with enhanced fuel efficiency regulations (enhance 54% fuel efficiency regulation by 2025 in North America) has been urgently demanded and a multi-speed automatic transmission is rapidly growing in the North America market and thus a mounting rate of an automatic transmission of 7 stages or more is expected to be increased 39% or more (based on IHS Automotive '13.1) in the North America market since 2019. Therefore, a development for an automatic transmission of 8 speeds or more to realize high fuel efficiency or more has actively progressed.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a multi-speed automatic transmission capable of effectively implementing 10 forward speeds or more and 1 reverse stage by configuring a plurality of planetary gear sets and a plurality of friction elements to obtain higher gear efficiency.

According to various aspects of the present invention, a multi-speed automatic transmission may include a first planetary gear set connected to a transmission input shaft, a second planetary gear set connected to the first planetary gear set, a third planetary gear set connected to the second planetary gear set, a fourth planetary gear set connected between the third planetary gear set and a transmission output shaft, and six friction elements configured to selectively couple and decouple a connection among the first to fourth planetary gear sets to generate various gear ratios between the transmission input shaft and the transmission output shaft so as to implement a plurality of gear stages, in which at least three of the six friction elements are selectively coupled and operated at each gear stage.

The first planetary gear set may include a first sun gear, a first carrier, and a first ring gear, the second planetary gear set may include a second sun gear, a second carrier, and a second ring gear, the third planetary gear set may include a third sun gear, a third carrier, and a third ring gear, the fourth planetary gear set may include a fourth sun gear, a fourth carrier, and a fourth ring gear, the first ring gear of the first planetary gear set and the second sun gear of the second planetary gear set may be fixedly connected to each other, the second sun gear of the second planetary gear set and the third sun gear of the third planetary gear set may be fixedly connected to each other, the second ring gear of the second planetary gear set and the third carrier of the third planetary gear set may be fixedly connected to each other, and the third carrier of the third planetary gear set and the fourth ring gear of the fourth planetary gear set may be fixedly connected to each other.

The transmission input shaft may be connected to the first carrier of the first planetary gear set and the transmission output shaft may be connected to the fourth carrier of the fourth planetary gear set.

The six friction elements may include three clutches and three brakes.

The three clutches may include a first clutch connected to the first carrier of the first planetary gear set and the second carrier of the second planetary gear set to selectively couple and decouple the first carrier to and from the second carrier, a second clutch connected to the first sun gear of the first planetary gear set and the second carrier of the second planetary gear set to selectively couple and decouple the first sun gear to and from the second carrier, and a third clutch connected to the third sun gear of the third planetary gear set and the transmission output shaft to selectively couple and decouple the third sun gear of the third planetary gear set to and from the transmission output shaft.

The third clutch may be connected to the third sun gear of the third planetary gear set and the transmission output shaft and the fourth planetary gear set to selectively couple and decouple the third sun gear to and from the transmission output shaft and the fourth planetary gear set.

The three brakes may include a first brake connected to the first sun gear of the first planetary gear set to be selectively coupled and decoupled to and from the first sun gear, a second brake connected to the third ring gear of the third planetary gear set to be selectively coupled and decoupled to and from the third ring gear, and a third brake connected to the fourth sun gear of the fourth planetary gear set to be selectively coupled and decoupled to and from the fourth sun gear.

10 forward speeds and a 1 reverse stage may be implemented by a selective coupling and decoupling operation of the friction elements, a forward 1st gear stage may be provided by coupling and operating the second clutch, the second brake, and the third brake, a forward 2nd gear stage may be provided by coupling and operating the first clutch, the second brake, and the third brake, a forward 3rd gear stage may be provided by coupling and operating the first clutch, the first brake, and the third brake, a forward 4th gear stage may be provided by coupling and operating the first clutch, the second clutch, and the third brake, a forward 5th gear stage may be provided by coupling and operating the first clutch, the third clutch, and the third brake, a forward 6th gear stage may be provided by coupling and operating the second clutch, the third clutch, and the third brake, a forward 7th gear stage may be provided by coupling and operating the first clutch, the second clutch, and the third clutch, a forward 8th gear stage may be provided by coupling and operating the second clutch, the third clutch, and the second brake, a forward 9th gear stage may be provided by coupling and operating the third clutch, the first brake, and the second brake, a forward 10th gear stage may be provided by coupling and operating the first clutch, the third clutch, and the second brake, and a reverse gear stage may be provided by coupling and operating the second clutch, the first brake, and the third brake.

10 forward speeds and a 1 reverse stage are implemented by a selective coupling and decoupling operation of the friction elements, a forward 1st gear stage may be provided by coupling and operating the second clutch, the second brake, and the third brake, a forward 2nd gear stage may be provided by coupling and operating the first brake, the second brake, and the third brake, a forward 3rd gear stage may be provided by coupling and operating the first clutch, the second brake, and the third brake, a forward 4th gear stage may be provided by coupling and operating the first clutch, the first brake, and the third brake, a forward 5th gear stage may be provided by coupling and operating the first clutch, the second clutch, and the third brake, a forward 6th gear stage may be provided by coupling and operating the first clutch, the third clutch, and the third brake, a forward 7th gear stage may be provided by coupling and operating the second clutch, the third clutch, and the third brake, a forward 8th gear stage may be provided by coupling and operating the first clutch, the second clutch, and the third clutch, a forward 9th gear stage may be provided by coupling and operating the second clutch, the third clutch, and the second brake, a forward 10th gear stage may be provided by coupling and operating the third clutch, the first brake, and the second brake, a forward 11th gear stage may be provided by coupling and operating the first clutch, the third clutch, and the second brake, and a reverse gear stage may be provided by coupling and operating the second clutch, the first brake, and the third brake.

According to various aspects of the present invention, a multi-speed automatic transmission may include a transmission input shaft, a transmission output shaft, four planetary gear sets arranged between the transmission input shaft and the transmission output shaft, and six friction elements configured to generate various gear ratios between the transmission input shaft and the transmission output shaft by a selective coupling and decoupling operation so as to implement a plurality of gear stages, in which at least three of the six friction elements are operated to be selectively coupled at each gear stage.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a configuration diagram of an exemplary multi-speed automatic transmission according to the present invention.

FIG. 2 is a diagram illustrating an operation table of six friction elements for implementing 10 forward speeds and 1 reverse stage by the exemplary multi-speed automatic transmission according to the present invention.

FIG. 3 is a diagram illustrating an operation table of six friction elements for implementing 11 forward speeds and 1 reverse stage by the exemplary multi-speed automatic transmission according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

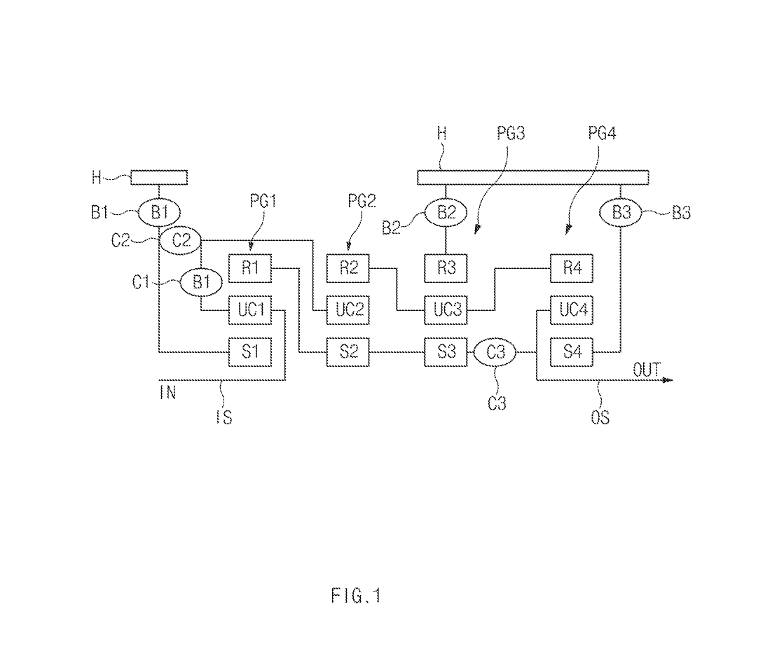

As illustrated in FIG. 1, a multi-speed automatic transmission according to various embodiments of the present invention includes a transmission input shaft IS, a transmission output shaft OS, four planetary gear sets PG1, PG2, PG3, and PG4 which are arranged between the transmission input shaft IS and the transmission output shaft OS, and six friction elements C1, C2, C3, B1, B2, and B3 which generate various gear ratios between the transmission input shaft IS and the transmission output shaft OS by a selective coupling and decoupling operation to implement a plurality of gear stages.

The four planetary gear sets PG1, PG2, PG3, and PG4 are configured of a first planetary gear set PG1 which is connected to the transmission input shaft IS, a second planetary gear set PG2 which is connected to the first planetary gear set PG1, a third planetary gear set PG3 which is connected to the second planetary gear set PG2, and a fourth planetary gear set PG4 which is connected between the third planetary gear set PG3 and the transmission output shaft OS.

The first planetary gear set PG1 has a first sun gear S1, a first carrier UC1, and a first ring gear R1. In this configuration, the first sun gear S1 is variably connected to a transmission case H by a first brake B1 to be described later, the first carrier UC1 is configured to integrally connect a plurality of single pinions which are meshed between the first sun gear S1 and the first ring gear R1, and the first ring gear R1 is meshed with the plurality of single pinions with being externally contacted therewith. Further, the first carrier UC1 is fixedly connected to the transmission input shaft IS.

The second planetary gear set PG2 has a second sun gear S2, a second carrier UC2, and a second ring gear R2. Here, the second sun gear S2 is fixedly connected to the first ring gear R1 of the first planetary gear set PG1, the second carrier UC2 is configured to integrally connect a plurality of single pinions which are meshed between the second sun gear S2 and the second ring gear R2, and the second ring gear is meshed with the plurality of single pinions with being externally contacted therewith.

The third planetary gear set PG3 has a third sun gear S3, a third carrier UC3, and a third ring gear R3. In this configuration, the third sun gear S3 is fixedly connected to the second sun gear S2 of the second planetary gear set PG2, the third carrier UC3 is fixedly connected to the second ring gear R2 of the second planetary gear set PG2, the third carrier UC3 is configured to integrally connect a plurality of single pinions which are meshed between the third sun gear S3 and the third ring gear R3, and the third ring gear R3 is meshed with the plurality of single pinions with being externally contacted therewith.

The fourth planetary gear set PG4 has a fourth sun gear S3, a fourth carrier UC4, and a fourth ring gear R4. In this configuration, the fourth sun gear S4 is fixedly connected to the transmission output shaft OS, the fourth carrier UC4 is configured to integrally connect a plurality of single pinions which are meshed between the fourth sun gear S4 and the fourth ring gear R4, the fourth ring gear R4 is meshed with the plurality of single pinions with being externally contacted therewith, and the fourth ring gear R4 is fixedly connected to the third carrier UC3 of the third planetary gear set PG3.

As such, according to various embodiments of the present invention, the first ring gear R1 of the first planetary gear set PG1 is fixedly connected to the second such gear S2 of the second planetary gear set PG2, the second sun gear S2 of the second planetary gear set PG2 is fixedly connected to the third sun gear S3 of the third planetary gear set PG3, the second ring gear R2 of the second planetary gear set PG2 is fixedly connected to the third carrier UC3 of the third planetary gear set PG3, the third carrier UC3 of the third planetary gear set PG3 is fixedly connected to the fourth ring gear R4 of the fourth planetary gear set PG4, the transmission input shaft IS is connected to the first carrier UC1 of the first planetary gear set PG1, and the transmission output shaft OS is connected to the fourth carrier UC4 of the fourth planetary gear set PG4, such that the four planetary gear sets PG1, PG2, PG3, and PG4 are arranged to be sequentially connected between the transmission input shaft IS and the transmission output shaft OS.

As illustrated in FIG. 1, the six friction elements C1, C2, C3, B1, B2, and B3 are configured of the three clutches C1, C2, and C3 and the three brakes B1, B2, and B3.

The three clutches C1, C2, and C3 include the first clutch C1, the second clutch C2, and the third clutch C3.

The first clutch C1 is connected to the first carrier UC1 of the first planetary gear set PG1 and the second carrier UC2 of the second planetary gear set PG2 to selectively couple and decouple the first carrier UC1 of the first planetary gear set PG1 with and from the second carrier UC2 of the second planetary gear set PG2, the second clutch C2 is connected to the first sun gear S1 of the first planetary gear set PG1 and the second carrier UC2 of the second planetary gear set PG2 to selectively couple and decouple the first sun gear S1 of the first planetary gear set PG1 with and from the second carrier UC2 of the second planetary gear set PG2, and the third clutch C3 is connected to the third sun gear S3 of the third planetary gear set PG3 and the transmission output shaft OS to selectively couple and decouple the third sun gear S3 of the third planetary gear set PG3 with and from the transmission output shaft OS.

Meanwhile, the third clutch C3 may be connected to the third sun gear S3 of the third planetary gear set PG3 and the transmission output shaft OS and the fourth planetary carrier UC4 of the fourth planetary gear set PG2 to selectively couple and decouple the third sun gear S3 of the third planetary gear set PG2 with and from the transmission output shaft OS and the fourth planetary carrier UC4 of the fourth planetary gear set PG2. Therefore, more various gear stages may be implemented by the selective operation of the third clutch C3.

The three brakes B1, B2, and B3 include a first brake B1, a second brake B2, and a third brake B3.

The first brake B1 is installed in the transmission housing H and is connected to the first sun gear S1 of the first planetary gear set PG1 to selectively couple and decouple the first sun gear S1 of the first planetary gear set PG1.

The second brake B2 is installed in the transmission housing H and is connected to the third ring gear R3 of the third planetary gear set PG3 to selectively couple and decouple the third ring gear R3 of the third planetary gear set PG3.

The third brake B3 is installed in the transmission housing H and is connected to the fourth sun gear S4 of the fourth planetary gear set PG4 to selectively couple and decouple the fourth sun gear S4 of the fourth planetary gear set PG4.

At least three of the six friction elements C1, C2, C3, B1, B2, and B3 are selectively coupled and operated at each gear stage to facilitate the multi-speed shift of 10 forward speeds or more.

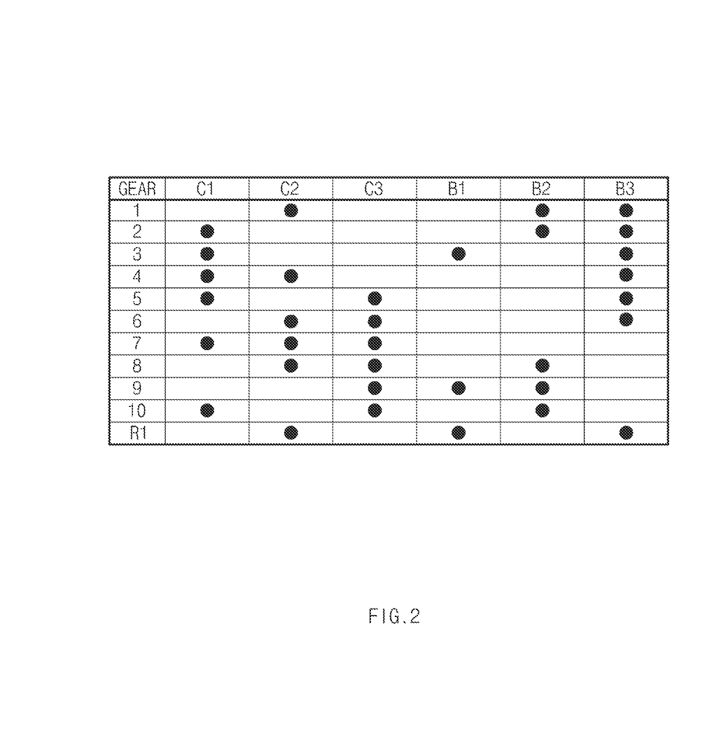

FIG. 2 is an operation table illustrating an operation relationship of the friction elements C1, C2, C3, B1, B2, and B3 by the multi-speed automatic transmission according to various embodiments of the present invention.

As illustrated in FIG. 2, the multi-speed automatic transmission according to various embodiments of the present invention may implement the 10 forward speeds and the forward 1 stage by the appropriate coupling and decoupling operation of the friction elements.

Describing this in detail, a forward 1st gear stage may be provided by coupling and operating the second clutch C2, the second brake B2, and the third brake B3, a forward 2nd gear stage may be provided by coupling and operating the first clutch C1, the second brake B2, and the third brake B3, a forward 3rd gear stage may be provided by coupling and operating the first clutch C1, the first brake B1, and the third brake B3, a forward 4th gear stage may be provided by coupling and operating the first clutch C1, the second clutch C2, and the third brake B3, a forward 5th gear stage may be provided by coupling and operating the first clutch C1, the third clutch C3, and the third brake B3, a forward 6th gear stage may be provided by coupling and operating the second clutch C2, the third clutch C3, and the third brake B3, a forward 7th gear stage may be provided by coupling and operating the first clutch C1, the second clutch C2, and the third clutch C3, a forward 8th gear stage may be provided by coupling and operating the second clutch C2, the third clutch C3, and the second brake B3, a forward 9th gear stage may be provided by coupling and operating the third clutch C3, the first brake B1, and the second brake B2, a 10th forward gear stage may be provided by coupling and operating the first clutch C1, the third clutch C3, and the second brake B2, and a backward gear stage may be provided by coupling and operating the second clutch C2, the first brake B1, and the third brake B3.

Comparison results between the gear efficiencies when the 10 forward speeds and the 1 reverse stage is implemented by the exemplary embodiment of the present invention configured as described above and conventional examples are shown in the following Table 1.

TABLE 1

| | | | | | | The |
|---|---|---|---|---|---|---|
| Gear | Conventional | Conventional | Conventional | Conventional | Conventional | Present |
| Stage | Example 1 | Example 2 | Example 3 | Example 4 | Example 5 | Invention |
| 1 | 0.94 | 0.918 | 0.946 | 0.977 | 0.973 | 0.975 |
| 2 | 0.961 | 0.972 | 0.956 | 0.983 | 0.986 | 0.977 |
| 3 | 0.979 | 0.992 | 0.975 | 0.989 | 0.98 | 0.979 |
| 4 | 0.983 | 0.992 | 0.978 | 0.995 | 0.986 | 0.992 |
| 5 | 0.988 | 1 | 0.987 | 1 | 0.992 | 0.992 |
| 6 | 1 | 0.994 | 1 | 0.991 | 1 | 0.995 |
| 7 | 0.991 | 0.993 | 0.991 | 0.987 | 0.994 | 1.000 |
| 8 | 0.993 | 0.983 | 0.994 | 0.985 | 0.994 | 0.996 |
| 9 | | | | 0.971 | 0.988 | 0.994 |
| 10 | | | | | | 0.989 |
| Average | 0.979 | 0.981 | 0.978 | 0.986 | 0.988 | 0.989 |

As can be appreciated from the above Table 1, the whole average gear efficiency of the Present Invention is 98.9%, and therefore it may be appreciated that the gear efficiency of the Present Invention is more improved than those of the Conventional Examples 1, 2, 3, 4, and 5.

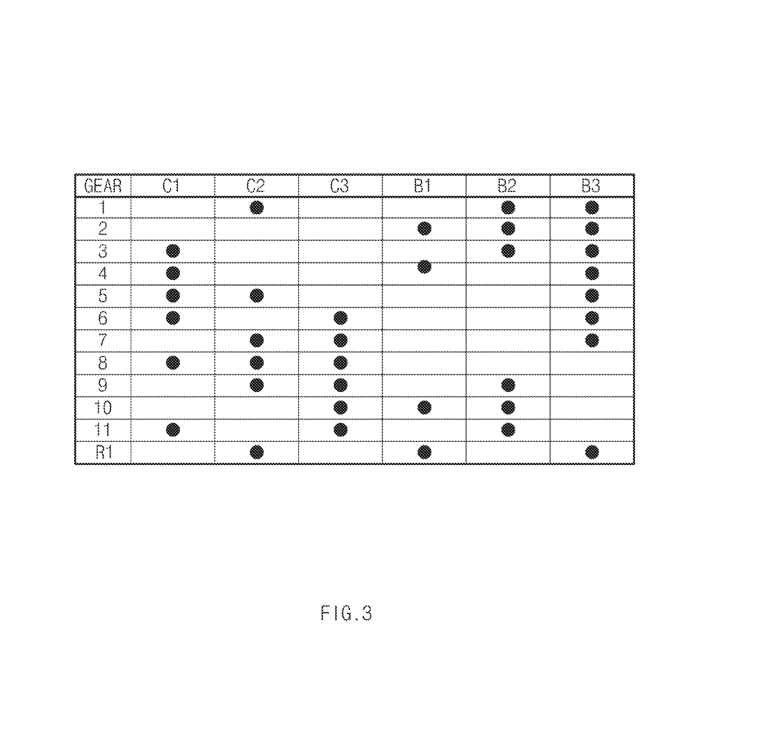

Meanwhile, according to the multi-speed automatic transmission according to various embodiments of the present invention, as illustrated in FIG. 3, 11 forward speeds and 1 reverse stage may be implemented.

Describing this in detail with reference to FIG. 3, a forward 1st gear stage may be provided by coupling and operating the second clutch C2, the second brake B2, and the third brake B3, a forward 2nd gear stage may be provided by coupling and operating the first brake B1, the second brake B2, and the third brake B3, a forward 3rd gear stage may be provided by coupling and operating the first clutch C1, the second brake B2, and the third brake B3, a forward 4th gear stage may be provided by coupling and operating the first clutch C1, the first brake B1, and the third brake B3, a forward 5th gear stage may be provided by coupling and operating the first clutch C1, the second clutch C2, and the third brake B3, a forward 6th gear stage may be provided by coupling and operating the first clutch C1, the third clutch C3, and the third brake B3, a forward 7th gear stage may be provided by coupling and operating the second clutch C2, the third clutch C3, and the third brake B3, a forward 8th gear stage may be provided by coupling and operating the first clutch C1, the second clutch C2, and the third clutch C3, a forward 9th gear stage may be provided by coupling and operating the second clutch C2, the third clutch C3, and the second brake B2, a 10th forward gear stage may be provided by coupling and operating the third clutch C3, the first brake B1, and the second brake B2, a forward 11th gear stage may be provided by coupling and operating the first clutch C1, the third clutch C3, and the second brake B2, and a reverse gear stage may be provided by coupling and operating the second clutch C2, the first brake B1, and the third brake B3.

As described above, according to various embodiments of the present invention, it is possible to obtain the higher gear efficiency and effectively implement 10 forward speeds or more and 1 reverse stage by sequentially interconnecting the four planetary gear sets and selectively coupling and decoupling among the four planetary gear sets by using the six friction elements.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A multi-speed automatic transmission, comprising:
a first planetary gear set connected to a transmission input shaft;
a second planetary gear set connected to the first planetary gear set;
a third planetary gear set connected to the second planetary gear set;
a fourth planetary gear set connected between the third planetary gear set and a transmission output shaft; and
six friction elements configured to selectively couple and decouple a connection among the first to fourth planetary gear sets to generate various gear ratios between the transmission input shaft and the transmission output shaft to implement a plurality of gear stages,
wherein at least three of the six friction elements are selectively coupled and operated at each gear stage.

2. The multi-speed automatic transmission according to claim 1, wherein the first planetary gear set comprises a first sun gear, a first carrier, and a first ring gear,
the second planetary gear set comprises a second sun gear, a second carrier, and a second ring gear,
the third planetary gear set comprises a third sun gear, a third carrier, and a third ring gear,
the fourth planetary gear set comprises a fourth sun gear, a fourth carrier, and a fourth ring gear,
the first ring gear of the first planetary gear set and the second sun gear of the second planetary gear set are fixedly connected to each other,
the second sun gear of the second planetary gear set and the third sun gear of the third planetary gear set are fixedly connected to each other,
the second ring gear of the second planetary gear set and the third carrier of the third planetary gear set are fixedly connected to each other, and
the third carrier of the third planetary gear set and the fourth ring gear of the fourth planetary gear set are fixedly connected to each other.

3. The multi-speed automatic transmission according to claim 2, wherein the transmission input shaft is connected to the first carrier of the first planetary gear set and the transmission output shaft is connected to the fourth carrier of the fourth planetary gear set.

4. The multi-speed automatic transmission according to claim 3, wherein the six friction elements comprise three clutches and three brakes.

5. The multi-speed automatic transmission according to claim 4, wherein the three clutches comprise:
a first clutch connected to the first carrier of the first planetary gear set and the second carrier of the second planetary gear set to selectively couple and decouple the first carrier to and from the second carrier;
a second clutch connected to the first sun gear of the first planetary gear set and the second carrier of the second planetary gear set to selectively couple and decouple the first sun gear to and from the second carrier; and
a third clutch connected to the third sun gear of the third planetary gear set and the transmission output shaft to selectively couple and decouple the third sun gear of the third planetary gear set to and from the transmission output shaft.

6. The multi-speed automatic transmission according to claim 5, wherein the third clutch is connected to the third sun gear of the third planetary gear set and the transmission output shaft and the fourth planetary gear set to selectively couple and decouple the third sun gear to and from the transmission output shaft and the fourth planetary gear set.

7. The multi-speed automatic transmission according to claim 6, wherein the three brakes comprise:
a first brake connected to the first sun gear of the first planetary gear set to be selectively coupled and decoupled to and from the first sun gear;
a second brake connected to the third ring gear of the third planetary gear set to be selectively coupled and decoupled to and from the third ring gear; and
a third brake connected to the fourth sun gear of the fourth planetary gear set to be selectively coupled and decoupled to and from the fourth sun gear.

8. The multi-speed automatic transmission according to claim 7, wherein 10 forward speeds and a 1 reverse stage are implemented by a selective coupling and decoupling operation of the friction elements,
a forward 1st gear stage is provided by coupling and operating the second clutch, the second brake, and the third brake,
a forward 2nd gear stage is provided by coupling and operating the first clutch, the second brake, and the third brake,
a forward 3rd gear stage is provided by coupling and operating the first clutch, the first brake, and the third brake,
a forward 4th gear stage is provided by coupling and operating the first clutch, the second clutch, and the third brake,
a forward 5th gear stage is provided by coupling and operating the first clutch, the third clutch, and the third brake,
a forward 6th gear stage is provided by coupling and operating the second clutch, the third clutch, and the third brake,
a forward 7th gear stage is provided by coupling and operating the first clutch, the second clutch, and the third clutch,
a forward 8th gear stage is provided by coupling and operating the second clutch, the third clutch, and the second brake,
a forward 9th gear stage is provided by coupling and operating the third clutch, the first brake, and the second brake,
a forward 10th gear stage is provided by coupling and operating the first clutch, the third clutch, and the second brake, and
a reverse gear stage is provided by coupling and operating the second clutch, the first brake, and the third brake.

9. The multi-speed automatic transmission according to claim 7, wherein 10 forward speeds and a 1 reverse stage are implemented by a selective coupling and decoupling operation of the friction elements,
a forward 1st gear stage is provided by coupling and operating the second clutch, the second brake, and the third brake,
a forward 2nd gear stage is provided by coupling and operating the first brake, the second brake, and the third brake,
a forward 3rd gear stage is provided by coupling and operating the first clutch, the second brake, and the third brake,
a forward 4th gear stage is provided by coupling and operating the first clutch, the first brake, and the third brake,
a forward 5th gear stage is provided by coupling and operating the first clutch, the second clutch, and the third brake,
a forward 6th gear stage is provided by coupling and operating the first clutch, the third clutch, and the third brake,
a forward 7th gear stage is provided by coupling and operating the second clutch, the third clutch, and the third brake,
a forward 8th gear stage is provided by coupling and operating the first clutch, the second clutch, and the third clutch,
a forward 9th gear stage is provided by coupling and operating the second clutch, the third clutch, and the second brake,
a forward 10th gear stage is provided by coupling and operating the third clutch, the first brake, and the second brake,
a forward 11th gear stage is provided by coupling and operating the first clutch, the third clutch, and the second brake, and
a reverse gear stage is provided by coupling and operating the second clutch, the first brake, and the third brake.

10. A multi-speed automatic transmission, comprising:
a transmission input shaft;
a transmission output shaft;
four planetary gear sets arranged between the transmission input shaft and the transmission output shaft; and
six friction elements configured to generate various gear ratios between the transmission input shaft and the transmission output shaft by a selective coupling and decoupling operation to implement a plurality of gear stages,
wherein at least three of the six friction elements are operated to be selectively coupled at each gear stage.

11. The multi-speed automatic transmission according to claim 10, wherein the six friction elements comprise three clutches and three brakes.
